(19) United States
(12) Patent Application Publication
(10) Pub. No.: US 2019/0383475 A1
(43) Pub. Date: Dec. 19, 2019

(54) LED LAMP

(71) Applicant: EVERY INDUSTRY LLC, Rancho Dominguez, CA (US)

(72) Inventor: Jinsheng DENG, Rancho Dominguez, CA (US)

(21) Appl. No.: 16/180,653

(22) Filed: Nov. 5, 2018

(30) Foreign Application Priority Data
Jun. 19, 2018 (CN) 201820948333.0

(51) Int. Cl. F21V 21/34; F21S 4/28; F21V 21/14; F21V 21/005

(52) U.S. Cl. CPC F21V 21/34; F21S 4/28; F21Y 2115/10; F21V 21/005; F21V 21/14

(57) ABSTRACT

A light emitting diode (LED) lamp includes a power supply box; a sliding mechanism mounted on the power supply box; and an LED light bar mounted on the sliding mechanism. The sliding mechanism includes a bracket, a fixing plate slidably connected to the bracket, and two adjustment assemblies mounted on both ends of the bracket. The LED light bar is fixed on the fixing plate. Each adjustment assembly includes a positioning shaft mounted on a side of the power supply box, a fixing lock washer and a rotating lock washer sleeved on the positioning shaft. A side of the fixing lock washer facing the rotating lock washer is engaged with a side of the rotating lock washer facing the fixing lock washer. The fixing lock washer is fixed to the power supply box, and the rotating lock washer is fixed to an end of the bracket.

### CROSS-REFERENCE TO RELATED APPLICATIONS

This application claims priority to Chinese Patent Application No. 2018209483330, entitled “DETACHABLE LED LAMP” filed Jun. 19, 2018, the contents of which is expressly incorporated herein by reference in its entirety.

### TECHNICAL FIELD

The present disclosure relates to lamp technologies, and more particularly relates to a light emitting diode (LED) lamp.

### BACKGROUND

Lamp is a necessity for modern life. LED lamp, as one kind of the lamp, has characteristics of energy saving, environmental protection, long usage, small size, and the like, therefore the LED lamp is widely used in various fields such as indication, display, decoration, backlight, general illumination and urban night scene and the like.

In a conventional LED lamp, a light bar is non-detachably connected with a power supply box, which makes the conventional LED lamp take up a large space when accommodating, therefore not only increasing packaging cost and transportation cost, but also making it inconvenient for maintenance and replacement. In addition, an application scope of the LED lamp is limited due to an unadjustable angle of the light bar.

### SUMMARY

According to various embodiments of the present disclosure, an LED lamp is provided.

An LED lamp includes a power supply box; a sliding mechanism mounted on the power supply box; and an LED light bar mounted on the sliding mechanism. The sliding mechanism includes a bracket, a fixing plate slidably connected to the bracket, and two adjustment assemblies mounted on both ends of the bracket. The LED light bar is fixed on the fixing plate. Each adjustment assembly includes a positioning shaft mounted on a side of the power supply box, a fixing lock washer and a rotating lock washer sleeved on the positioning shaft. A side of the fixing lock washer facing the rotating lock washer is engaged with a side of the rotating lock washer facing the fixing lock washer. The fixing lock washer is fixed to the power supply box, and the rotating lock washer is fixed to an end of the bracket.

The details of one or more implementations of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a perspective view of an LED lamp in accordance with an embodiment.

FIG. 2 is a left-side elevational view of the LED lamp of FIG. 1.

FIG. 3 is a perspective view illustrating a sliding mechanism of the LED lamp of FIG. 1.

FIG. 4 is an exploded view of the sliding mechanism of FIG. 3.

FIG. 5 is a perspective view of a fixing plate of FIG. 4.

FIG. 6 is an enlarged view of a portion A of the LED lamp of FIG. 2.

FIG. 7 is a partial, exploded view of the LED lamp of FIG. 1.

### DETAILED DESCRIPTION OF THE EMBODIMENTS

Reference will now be made to the drawings to describe, in detail, embodiments of the present LED lamp. It should be noted that references to “an” or “one” embodiment in this disclosure are not necessarily to the same embodiment, and such references mean at least one.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list.

It should be noted that when an element is referred to as being “fixed” or connected to another element, it can be directly fixed on or connected to the other element or the element can be indirectly fixed on or connected to the other element via one or more intermediate elements. Rather, when an element is referred to as being “directly fixed on” or “directly connected to” another element, then there is no intermediate element. The terms “vertical,” “horizontal,” “left,” “right,” and the like, as used herein, are for illustrative purposes only.

Referring to FIG. 1, an LED lamp in accordance with an embodiment includes a power supply box 10, at least one sliding mechanism 20, and at least one LED light bar 30.

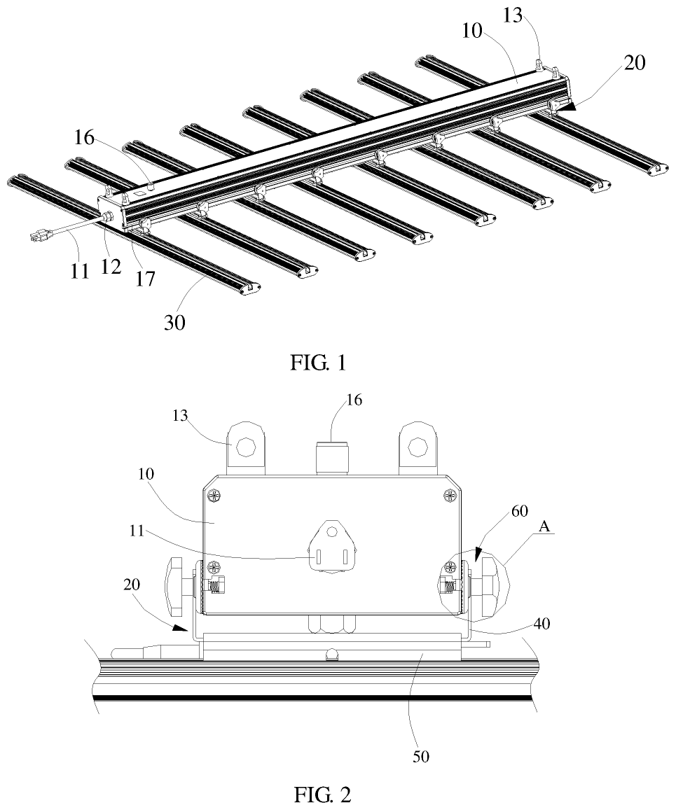

Referring to FIGS. 1 and 2, the power supply box 10 has a substantially cuboid shape. A power plug 11 extends out from an end of the power supply box 10. A first waterproof element 12 is provided at a joint of the power plug 11 and an end surface of the power supply box 10 to prevent external dust and mist from entering the power supply box 10. The power supply box 10 is provided with at least one lifting eye 13 on a top side thereof, such that the power supply box 10 can be fixed to a wall or roof via screws or cables. In the illustrated embodiment, the number of the lifting eye 13 is four, and the four lifting eyes 13 are located at four corners of the top side of the power supply box 10. The power supply box 10 is further provided with a knob 16. In one embodiment, the knob 16 is located on the top side of the power supply box 10 and coupled to an adjustment module (not shown) in the power supply box 10. The brightness of the LED light bar 30 can be adjusted via rotating the knob 16. The power supply box 10 defines two positioning slots 17 on opposite sides thereof respectively. In one embodiment, each slot 17 has a substantially convex cross-section.

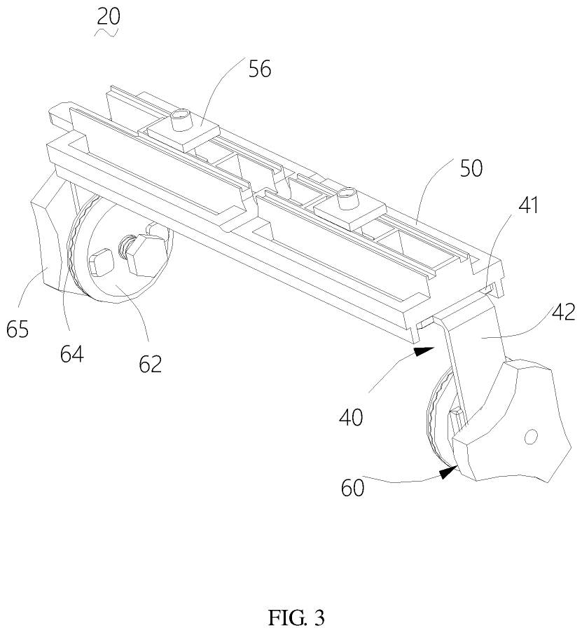

The sliding mechanism 20 is mounted on the power supply box 10. Referring to FIG. 3, the sliding mechanism 20 includes a bracket 40, a fixing plate 50, and two adjustment assemblies 60. The fixing plate 50 is slidably connected to the bracket 40. The two adjustment assemblies 60 are respectively mounted on both ends of the bracket 40.

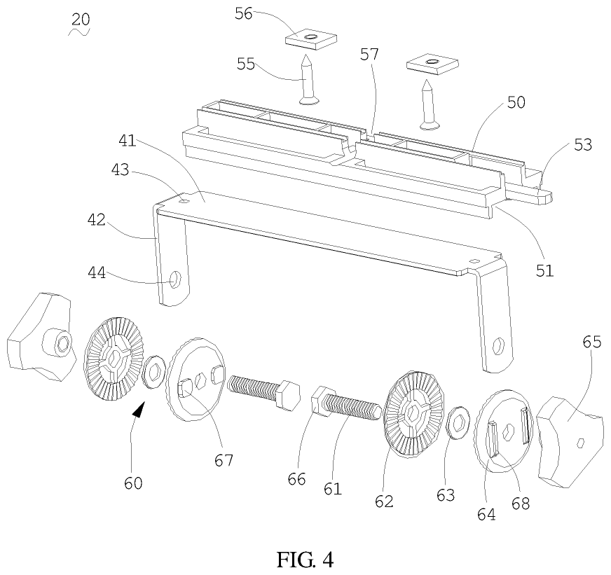

Referring to FIG. 4, in the illustrated embodiment, the bracket 40 has a substantially U-shape. Both ends of the bracket 40 are respectively located at opposite sides of the power supply box 10. The bracket 40 includes a base plate 41 and two connecting plates 42 extending downwardly from both opposite ends of the base plate 41, respectively. Both ends of the base plate 41 define a positioning hole 43 respectively to position the fixing plate 50. In one embodiment, the two connecting plates 42 are parallel with each other and both extend vertically from both opposite ends of the base plate 41. The two connecting plates 42 are respectively located at both sides of the power supply box 10. An end of each connecting plate 42 away from the base plate 41 defines a shaft hole 44.

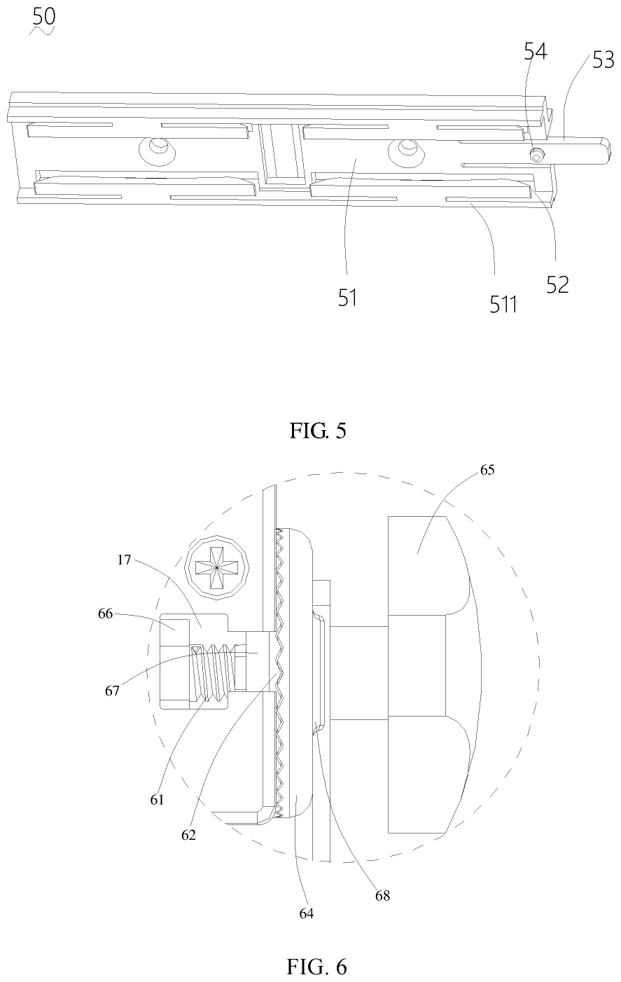

Referring FIGS. 4 and 5, the fixing plate 50 is slidably connected to the base plate 41. The fixing plate 50 defines a sliding slot 51 on a bottom side thereof. In the illustrated embodiment, the sliding slot 51 is cooperatively formed by the bottom surface of the fixing plate 50, two bending portions 511 extending perpendicular from both sides of the fixing plate 50, and two blocking portions 52 extending inwardly from each end of the bending portion 511. The base plate 41 is slidably received inside the sliding slot 51. One end of the fixing plate 50 is provided with an elastic piece 53. In one embodiment, the elastic piece 53 and the fixing plate 50 are integrally formed. The elastic piece 53 has a bump 54 on a bottom side thereof. When the fixing plate 50 slides on the base plate 41 to a specific location, the bump 54 is snappingly received in one of the positioning holes 43 to keep the fixing plate 50 in that position. When it is required to slide the fixing plate 50, the elastic piece 53 can be pulled up to detach the bump 54 from the positioning hole 43.

The fixing plate 50 is used to fix the LED light bar 30. In the illustrated embodiment, the fixing plate 50 is provided with a positioning block 56. Referring to FIG. 1, a side of the LED light bar 30 defines a receiving groove 31 to receive the positioning block 56. A screw 55 extends through the fixing plate 50 and the LED light bar 30 and is threadedly fixed to the positioning block 56, so as to fix the LED light bar 30 on a top surface of the fixing plate 50. The top surface of the fixing plate 50 defines a guiding slot 57 to receive electrical cables coupling the LED light bar 30 to the power supply box 10.

Referring to FIGS. 5 and 6, the adjustment assembly 60 includes a positioning shaft 61, a fixing lock washer 62, a damping piece 63, a rotating lock washer 64, and a handle 65.

The positioning shaft 61 is mounted on a side of the power supply box 10. In one embodiment, the positioning shaft 61 is pivotally connected to the connecting plate 42. In the illustrated embodiment, the positioning shaft 61 is a bolt extending through the shaft hole 44 of the connecting plate 42. A hex nut 66 is provide on the an end of the positioning shaft and located inside the positioning slot 17, as shown in FIG. 3.

The fixing lock washer 62 and the rotating lock washer 64 are both sleeved on the positioning shaft 61. A side of the fixing lock washer 62 is engaged with a side of the rotating lock washer 64. The fixing lock washer 62 is fixed to the power supply box 10. In the illustrated embodiment, a side of the fixing lock washer 62 away from the rotating lock washer 64 is provided with a latching block 67, which is latched in one of the positioning slot 17 to prevent the fixing lock washer 62 from rotating with a rotation of the rotating lock washer 64. The number of the latching block 67 is two, and the two latching blocks 67 are spaced apart from each other.

The damping piece 63 is sleeved on the positioning shaft 61 and located between the fixing lock washer 62 and the rotating lock washer 64.

The rotating lock washer 64 is fixed to an end of bracket 40. In one embodiment, the rotating lock washer 64 is fixed to an end of the connecting plate 42 away from the base plate 41. In the illustrated embodiment, a side of the rotating lock washer 64 away from the fixing lock washer 62 is provided with two limiting blocks 68. The two limiting blocks 68 are spaced apart from each other. The end of the connecting plate 42 away from the base plate 41 is clamped between the two limiting blocks 68, therefore the connecting plate 42 and the rotating lock washer 64 are fixed together. When rotating the LED light bar 30 with respect to the power supply box 10, the bracket 40 and the fixing plate 50 are driven to rotate, such that the rotating lock washer 64 is rotated with respect to the fixing lock washer 62 while overcoming the friction between the two, therefore an angle adjustment of the LED light bar 30 with respect to the power supply box 10 is achieved. In one embodiment, the angle adjustment of the LED light bar 30 ranges from 0° to 120°, that is, the angle adjustment of the LED light bar 30 with respect to the power supply box 10 ranges from 0° to 60° along a clockwise direction and a counterclockwise direction respectively.

The handle 65 is located at the side of the rotating lock washer 64 away from the fixing lock washer 62 and threadedly connected to an end of the positioning shaft 61. The handle 65 is used to adjust a tightness between the rotating lock washer 64 and the fixing lock washer 62. When it is required to adjust the angle of the LED light bar 30 with respect to the power supply box 10, the handle 65 is rotated clockwise to enable a rotation of the rotating lock washer 64 with respect to the fixing lock washer 62, and when the adjustment of the LED light bar 30 is completed, the handle 65 is rotated counterclockwise to prevent the rotating lock washer 64 from rotating with respect to the fixing lock washer 62.

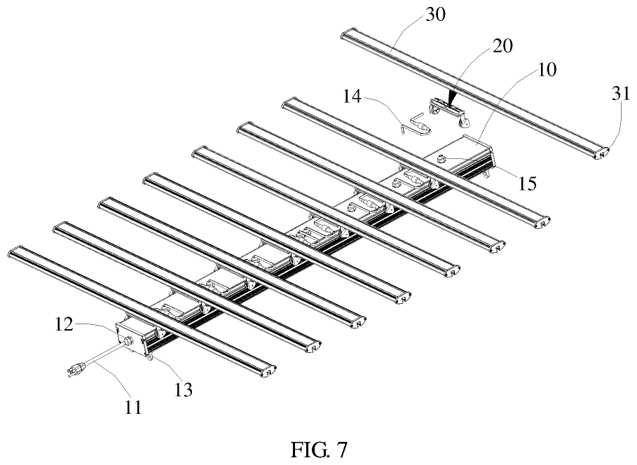

Referring to FIGS. 1 and 7, the LED light bar 30 is mounted on the sliding assembly 20 and electrically connected to the power supply box 10. In one embodiment, the LED light bar 30 is fixed on the fixing plate 50. In one embodiment, the LED light bar 30 is electrically coupled to the power supply box 10 via a male-female connector 14, in other words, an end of the male-female connector 14 is coupled to the LED light bar 30 and the other end of the male-female connector 14 is coupled to power supply box 10. When the LED light bar 30 is detached from the power supply box 10, a male plug of the male-female connector 14 can be detached from a female plug thereof. In one embodiment, the end of the male-female connector 14 is coupled to a bottom of the power supply box 10. In on embodiment, a second waterproof element 15 is provided at a joint of the male-female connector 14 and a bottom outer surface of the power supply box 10 to prevent external dust and mist from entering the power supply box 10. In one embodiment, the number of the LED light bar 30 is eight and the eight LED light bars 30 are spaced apart from each other.

In the aforementioned LED lamp, the bracket 40 is connected to the power supply box 10 via the adjustment assembly 60 and the LED light bar 30 is fixed to the fixing plate 50 slidably connected to the bracket 40, therefore the LED light bar 30 can be detached from the power supply box 10, which can not only reduce space occupation, packaging cost and transportation cost, but also make it convenient to disassembly or assembly the LED lamp, thus make it convenient for maintenance and replacement of the LED lamp. In addition, when rotating the LED light bar 30 with respect to the power supply box 10, the bracket 40 and the fixing plate 50 are driven to rotate, such that the rotating lock washer 64 is rotated with respect to the fixing lock washer 62 while overcoming the friction between the two, therefore an angle adjustment of the LED light bar 30 with respect to the power supply box 10 is achieved, and an application scope of the LED lamp is increased.

The technical features of the above embodiments can be arbitrarily combined. For the sake of brevity of description, all possible combinations of the technical features in the above embodiments are not described. However, as long as there is no collision in the combination of these technical features, it should be considered as the scope described in this specification.

The foregoing implementations are merely specific embodiments of the present disclosure, and are not intended to limit the protection scope of the present disclosure. It should be noted that any variation or replacement readily figured out by persons skilled in the art within the technical scope disclosed in the present disclosure shall all fall into the protection scope of the present disclosure. Therefore, the protection scope of the present disclosure shall be subject to the protection scope of the claims.

What is claimed is:

1. A light emitting diode (LED) lamp, comprising:
a power supply box;
a sliding mechanism mounted on the power supply box; and
an LED light bar mounted on the sliding mechanism;
wherein the sliding mechanism comprises a bracket, a fixing plate slidably connected to the bracket, and two adjustment assemblies mounted on both ends of the bracket; the LED light bar is fixed on the fixing plate;
wherein each of the two adjustment assemblies comprises a positioning shaft mounted on a side of the power supply box, a fixing lock washer and a rotating lock washer sleeved on the positioning shaft; a side of the fixing lock washer facing the rotating lock washer is engaged with a side of the rotating lock washer facing the fixing lock washer, the fixing lock washer is fixed to the power supply box, and the rotating lock washer is fixed to an end of the bracket.

2. The LED lamp of claim 1, wherein the bracket comprises a base plate and two connecting plates extending from both opposite ends of the base plate, the two connecting plates are located at both sides of the power supply box, respectively, the positioning shaft is pivotally connected to the connecting plate, the fixing plate defines a sliding slot on a bottom side thereof, and the base plate is slidably received in the sliding slot.

3. The LED lamp of claim 2, wherein both ends of the base plate define positioning holes, one end of the fixing plate is provided with an elastic piece having a bump, the bump is detachably received in one of the positioning holes when the fixing plate slides on the base plate.

4. The LED lamp of claim 2, wherein a side of the rotating lock washer away from the fixing lock washer is provided with two limiting blocks spaced apart from each other; one end of the connecting plate away from the base plate is clamped between the two limiting blocks; the end of the connecting plate away from the base plate defines a shaft hole, and the positioning shaft extends through the shaft hole.

5. The LED lamp of claim 1, wherein each of the two adjustment assemblies further comprises a handle threadedly connected to an end of the positioning shaft, the handle is located at a side of the rotating lock washer away from the fixing lock washer.

6. The LED lamp of claim 1, wherein the power supply box defines two positioning slots on both sides thereof, respectively; the fixing lock washer is provided with a latching block on a side thereof away from the rotating lock washer, and the latching block is latched in one of the positioning slots.

7. The LED lamp of claim 1, wherein each of the adjustment assemblies further comprises a damping piece sleeved on the positioning shaft and located between the fixing lock washer and the rotating lock washer.

8. The LED lamp of claim 1, wherein the LED light bar is electrically coupled to the power supply box via a male-female connector.

9. The LED lamp of claim 1, wherein the power supply box is provided with at least one lifting eye on a top side thereof.

10. The LED lamp of claim 1, wherein the fixing plate is provided with a positioning block; the LED light bar defines a receiving groove, and the positioning block is received and fixed in the receiving groove via a screw extending therethrough.
